(19) United States
(12) Patent Application Publication
(10) Pub. No.: US 2017/0030571 A1
(43) Pub. Date: Feb. 2, 2017

(54) LAMPPOST WITH INNER COMPARTMENT FITTED INTO THE LAMPPOST BASE FOR TELECOMMUNICATIONS SYSTEMS

(71) Applicant: BIMETAL INDUSTRIA METALURGICA LTDA, Cuiabá (BR)

(72) Inventor: Walter Noboru KAWAHARA, Cuiaba (BR)

(73) Assignee: BIMETAL INDUSTRIA METALURGICA LTDA, Cuiaba (BR)

(21) Appl. No.: 15/039,805

(22) PCT Filed: Nov. 25, 2014
(86) PCT No.: PCT/BR2014/050021

§ 371 Date: May 26, 2016

(30) Foreign Application Priority Data
Nov. 26, 2013 (BR) BR102013030331-3

(51) Int. Cl. F21V 33/00; H04N 7/18; F21V 21/10; F21S 8/08; E04H 12/00; H04W 88/08

(52) U.S. Cl. CPC F21V 33/00; E04H 12/00; H04W 88/08; F21V 21/10; F21S 8/086; H04N 7/183

(57) ABSTRACT

The invention relates to a lamppost with an inner compartment fitted into the lamppost base for telecommunications systems (1), wherein all the systems can be installed inside the metal lamppost structure, on suitable shelves and racks (2), the shelves being made of metal wire screens to promote ventilation and cooling of the telecommunications systems, and the structure is made of weather-resistant hot-dip galvanized high-resistance steel, with reduced space requirements for its installation, since it does not have cabinets and other equipment arranged around its structure (3).

The present invention patent refers to technical and functional improvements created and introduced into a lamppost with compartment in its interior for placing the telecommunications systems. Its interior is strategically modulated with racks and shelves for placement and assembly of different systems commonly used in the telecommunications sector, remarkably for phone operators, either the fixed one or mobile.

Currently there is a very big variety of towers and posts for using phone operators sites or other purpose, but they are necessary external structures for placing systems and are commonly protected by a cabinet also called lockers, panels, Bts or also container, being these for placing and assembling inside the electrical and electronic systems used in phone operator. These cabinets are designed with the particularities, such that their constructive characteristics can meet the requirements and needs for installing systems, but most of these cabinets are designed for be exposed to weather, as documents BR PI9400666, BR PI9706453 e BR PI9901949.

The cabinets used for similar purpose have to be assembled from a masonry structural base and with all infrastructure to fit the systems where a terrain area of at least 9 m² is necessary, where there must be masonry walls and other safety materials for protection. Container-type metallic structures are also used and some types of cabinets do not need to be in acclimatized, closed environments, with walls protection, commonly called de BT's.

But all these solutions above need big areas for installation, wherein this makes its placement in several locations impossible, mainly in the big centers where, every single day, there is not the availability of space and there is also the need of checking the use requirements and limited ground occupancy by the protection organs. They also have a visual characteristic that in many cases, decharacterizes the environment as tour squares or in private places.

Most of cabinets used in phone operators and these activities are normally manufactured in ferrous materials in function of this type of equipment to be used outdoor, but as the structures of these cabinets generally are very big, they reach a considerable final cost and requires an assembly and slow displacement process.

The main object of the present invention is the configuration of a post with inner compartment in its own structure, placed on its base, able to offer better use and assembly resources for all internal and external components that need in the cabinet, but with an adverse constructive and adventurous concept regarding the state of the art previously mentioned.

The Post is able to bear all necessary systems installed inside the metallic structure itself, its interior is modulated for installing all systems such that there is no need of external cabinets to the structure or an auxiliary structure for this purpose, as is commonly used.

Also, the Post was developed to promote its assembly in any location since the same is easily transported and installed, reducing appreciably the costs and the space necessary for its installation. Further, due to systems are already placed coupled to lamppost base, cables for linking to the systems are not necessary and neither horizontal matting exiting from the structure until the systems that were already installed beside, having the big advantage of using small areas, and may be installed in houses background, squares or any area available, without needing walls or other protection means.

The Poste is constituted of a structure that may be developed with several shapes, and be conical or pyramidal with the necessary amount of apexes. And since it is easy to change the design of its external structure, protected by industrial design, it becomes easier to install in public places, not resulting in visual pollution and disorders to the environment.

The attached drawings show the Post with inner compartment placed in its base and all further requirements of a normal lamppost, installed in a small area of the terrain, which facilitates the use in any space, without causing disorders.

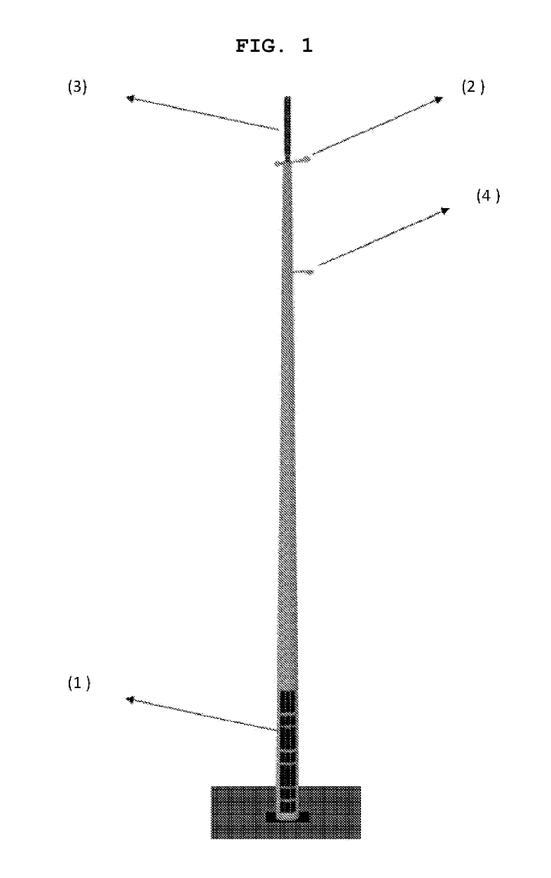

FIG. 01 shows a general view of the structure assembled from the post with the inner compartment on its base (1), with shelves and racks for placing the telecommunications system. Being the post too similar to a common lamppost, therein luminaries (2), data transmission antenna (3), security camera (4), or any other necessary equipment can be installed.

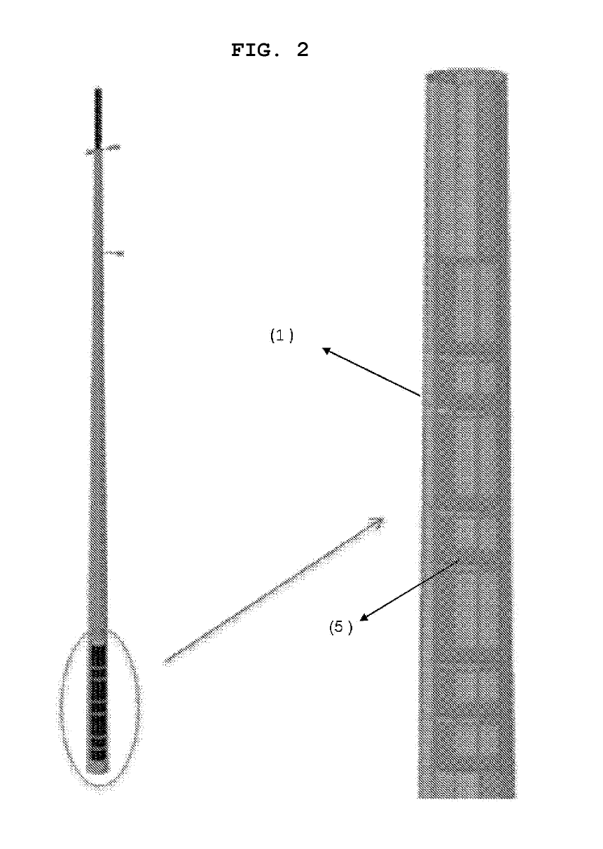

As FIG. 02 shows a perspective of the inner compartment installed in the lamppost base (1), with racks (5) or shelves for placing the systems necessary for fixed or mobile phone operator signal transmissions, ventilation systems, data and energy center, and auxiliary power source and these shelves are made of metal wire screens to promote the systems' ventilation and cooling. The post structure uses a very small territorial space, not needing walls or protection grids for these systems, since the post structure was already developed with reinforced material to be resistant and give total security to the systems installed therein.

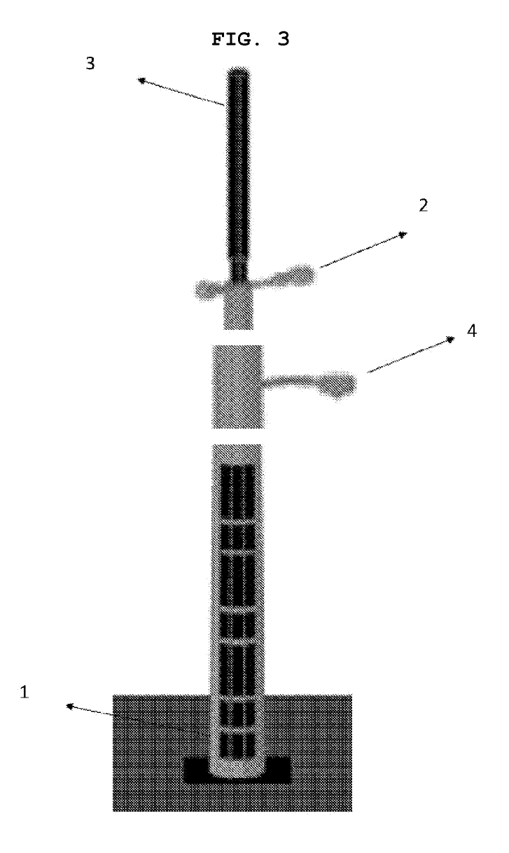

FIG. 03 shows details of all items that can be coupled to the lamppost with the inner compartment on the base (1) for installing telecommunications systems or any other type needed, the use of the same lamppost for luminaries (2), data transmission antennas (3) and also, the use of security cameras (4), being possible to be used with any other equipment needed.

1. LAMPPOST WITH INNER COMPARTMENT FITTED INTO ITS BASE FOR TELECOMMUNICATIONS SYSTEMS, wherein it comprises a modulated compartment fitted inside the lamppost base for installing systems used in the mobile and fixed phone transmission.

2. LAMPPOST, according to claim 1, wherein it has in the inner compartment, internal modular shelves for fixing the systems on these shelves made of metal wire screens to promote the ventilation and cooling of systems.

3. LAMPPOST, according to claim 1, wherein it is built in conical or pyramidal shape with the amount of apexes determined by the post size.

4. LAMPPOST, according to claim 1, wherein it enables the installation of luminaries and security cameras aiming the benefit of the community where the structure is installed.
